(19) United States
(12) Patent Application Publication
(10) Pub. No.: US 2014/0100764 A1
(43) Pub. Date: Apr. 10, 2014

(54) Method for operating an internal combustion engine

(71) Applicants: Ruediger Weiss, Moetzingen (DE); Andreas Schmidt, Muehlacker (DE); Manfred Dietrich, Markgroeningen (DE); Bernard Pawlok, Stuttgart (DE)

(72) Inventors: Ruediger Weiss, Moetzingen (DE); Andreas Schmidt, Muehlacker (DE); Manfred Dietrich, Markgroeningen (DE); Bernard Pawlok, Stuttgart (DE)

(73) Assignee: Robert Bosch GmbH, Stuttgart (DE)

(21) Appl. No.: 14/046,270

(22) Filed: Oct. 4, 2013

(30) Foreign Application Priority Data
Oct. 5, 2012 (DE) 10 2012 218 183.0

(51) Int. Cl. F02D 43/04

(52) U.S. Cl. CPC F02D 43/04
USPC 701/112

(57) ABSTRACT

A method is described for operating an internal combustion engine, the internal combustion engine including an angle of rotation sensor. In normal operation, a function is activated at a first angle of rotation. In stop operation, internal combustion engine is temporarily brought to a standstill. The function is activated in a start operation following the stop operation at a second angle of rotation, which follows the first angle of rotation in the direction of rotation.

RELATED APPLICATION INFORMATION

The present application claims priority to and the benefit of German patent application no. 10 2012 218 183.0, which was filed in Germany on Oct. 5, 2012, the disclosure of which is incorporated herein by reference.

### FIELD OF THE INVENTION

The present invention relates to a method for operating an internal combustion engine.

### BACKGROUND INFORMATION

Internal combustion engines are conventionally started using a so-called starter, which drives the internal combustion engine one or more revolutions in the process. So-called start/stop operating modes are also known, in which the internal combustion engine, in certain situations, is to be temporarily shut off and relatively currently, and particularly fast, is to be started again. In this connection, it is known that one may shut off the internal combustion engine at a standstill of the vehicle, for instance, at a traffic light, and to start it again when actuating the clutch or the accelerator pedal.

German documents DE 10 2008 005 525 A1 and DE 10 2010 040 562 A1, for example, discuss methods for improving the start/stop operating mode.

Again, it is believed to be understood that there are sensor systems which are no longer able sufficiently reliably to ascertain the crankshaft position if the time a tooth requires to sweep over a Hall sensor of the sensor system, exceeds a certain value, or when the crankshaft rotates counter to its regulate direction of rotation.

Furthermore, it is believed to be understood that functions in a control unit of the internal combustion engine are activated, in normal operation, crankshaft-synchronously and/or camshaft-synchronously, that is, they are activated at a certain angle of rotation. The sensor systems required for this are also believed to be understood.

### SUMMARY OF THE INVENTION

The object on which the present invention is based is attained by a method set forth herein. Advantageous refinements are indicated in the further descriptions herein.

A function whose angle of rotation for its activation in normal operation might already have elapsed, activation takes place in a start operation for restarting the internal combustion engine within the meaning of the subject matter described herein, and is thereby made up for. Because of the activation of the function, the probability is advantageously increased that firing of the first possible cylinder is able to take place. The method provided permits firing the first possible suitable cylinder as early as possible, i.e. at first reaching top dead center (ZOT—ignition top dead center) and to hold to as low as possible the so-called starting angle, i.e. the crankshaft angle which this cylinder has to cover between the standstill position and the first firing. With that, the restarting process is able to be carried out quickly and without protracted participation of the starter system. The starter system is spared thereby, disturbing noises are reduced, and the operating safety of the vehicle as well as driving comfort are increased.

In one specific embodiment of the method, it is ascertained whether a coasting-down angle, at which the internal combustion engine temporarily stands still, follows a first angle of rotation for the activation of the function, the execution of the function in normal operation being provided at the first angle of rotation. As a function of the ascertainment, the function is activated at a second angle of rotation. Thereby the standstill position within the meaning of the coasting-down angle is advantageously used to make up for the function. By making up for the function, the firing of the first possible cylinder may be carried out.

In one further specific embodiment of the method, in start operation an additional function is activated at a third angle of rotation, the activation of the additional function depending on whether the third angle of rotation follows the coast-down angle. In normal operation, the activation of the additional functions is provided at the third angle of rotation. With that, the angle of rotation for carrying out the additional function may advantageously be taken over from normal operation for the start operation.

In one alternative specific embodiment of the method, in the start operation, the function is activated at the second angle of rotation, which is at a distance of an angle of rotation difference in the direction of rotation from the associated first angle of rotation of normal operation. Because of this distancing, the probability is increased that the function is carried out, and leads to the firing of the first possible cylinder.

Important features for the present invention are also found in the following drawings, the features being able to be important for the present invention both alone and also in different combinations, without further explicit reference being made to it.

Exemplary specific embodiments of the present invention are elucidated in greater detail below, with reference to the appended drawings.

### BRIEF DESCRIPTION OF THE FIGURES

FIG. 1 shows a schematic representation of an internal combustion engine.

FIG. 2 shows a schematic state transition diagram including a start-stop functionality of the internal combustion engine.

FIG. 3 shows a schematic diagram of a working cycle of the internal combustion engine.

FIG. 4 shows another schematic diagram of a working cycle of the internal combustion engine.

FIG. 5 shows another schematic diagram of a working cycle of the internal combustion engine.

### DETAILED DESCRIPTION

The same reference numerals are used, even in different specific embodiments, for functionally equivalent elements and variables in all the figures.

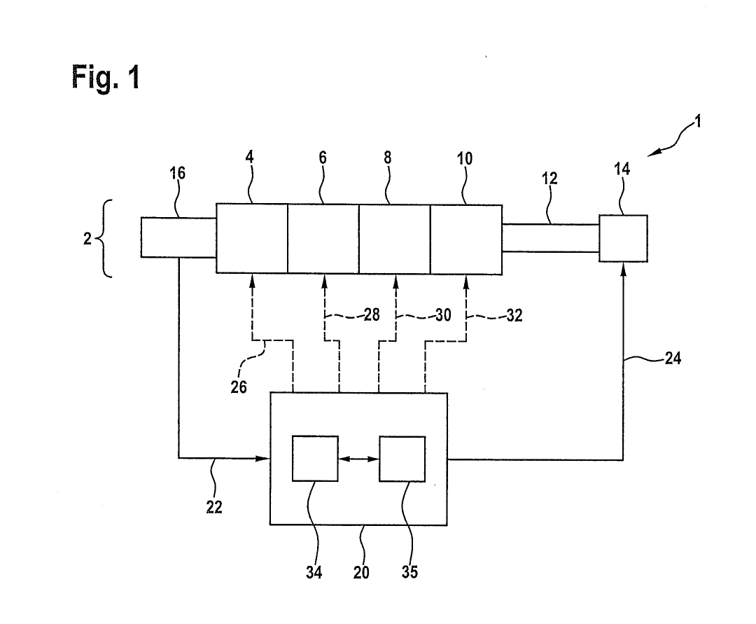

FIG. 1 shows a schematic representation 1 of an internal combustion engine 2 having a start-stop functionality for driving a motor vehicle. Internal combustion engine 2 includes four cylinders 4, 6, 8, 10, which have an ignition sequence 4-10-6-8, for example. A crankshaft 12 is connected to the combustion chambers of cylinders 4, 6, 8 and 10, via connecting rods and pistons. Crankshaft 12 is connected to a starting system 14 for starting internal combustion engine 2.

Starting system 14 may be an integrated starter generator on crankshaft 12, or a belt-driven starter generator. It is also conceivable, however, to use conventional starters. A camshaft, that is not shown, rotates at one-half the speed of the crankshaft and actuates fuel injectors, for instance, that are assigned to cylinders 4 through 10.

An angle of rotation sensor 16 is assigned to internal combustion engine 2, which may be to crankshaft 12. Angle of rotation sensor 16 is a sensor which indicates the angle of rotation position of crankshaft 12. In one specific embodiment, angle of rotation sensor 16 is made up of a sensor wheel fastened on crankshaft 16 and two Hall sensors. The sensor wheel has a tooth pattern, for example, a 6° arc section of the sensor wheel being assigned to one tooth. Two teeth are missing at a reference location. The Hall sensors scan the teeth and pass on the corresponding angle of rotation signal 22 to control unit 20. Using this angle of rotation sensor 16, the angle of rotation position of crankshaft 12 is recorded even during rotation of crankshaft 12 in the forwards and the backwards direction, which is why angle of rotation sensor 16 is also designated as an intelligent sensor system or an absolute angle sensor. During a first start, synchronization takes place via the gap. After this synchronization and as long as angle of rotation sensor 16 is supplied with current, the current angle of rotation position of crankshaft 12 is available via angle of rotation signal 22. Other specific embodiments of angle of rotation sensor 16 are, of course, also conceivable.

A control unit 20 of internal combustion engine 2 implements the start-stop functionality of internal combustion engine 2 and effects a fuel-injection blank-out for the automatic shutting down of internal combustion engine 2, particularly for the purpose of reduction in consumption or fuel saving. An angle of rotation signal 22 of angle of rotation sensor 16 is supplied to control unit 20, beside other signals.

A signal 24 is supplied to starting system 14, starting from control unit 20. Signals 26, 28, 30 and 32 are assigned to cylinders 26, 28, 30 and 32, which, starting from control unit 20, influence the respective combustion process.

According to one specific embodiment, the methods described here for controlling internal combustion engine 2 are implemented as a computer program suitable for this, that is able to be run by control unit 20. For the running of the computer program, control unit 20 includes a digital computer 34. The computer program is stored, for instance, on a storage medium 36 of control unit 20 and is loaded by digital computer 34 for execution.

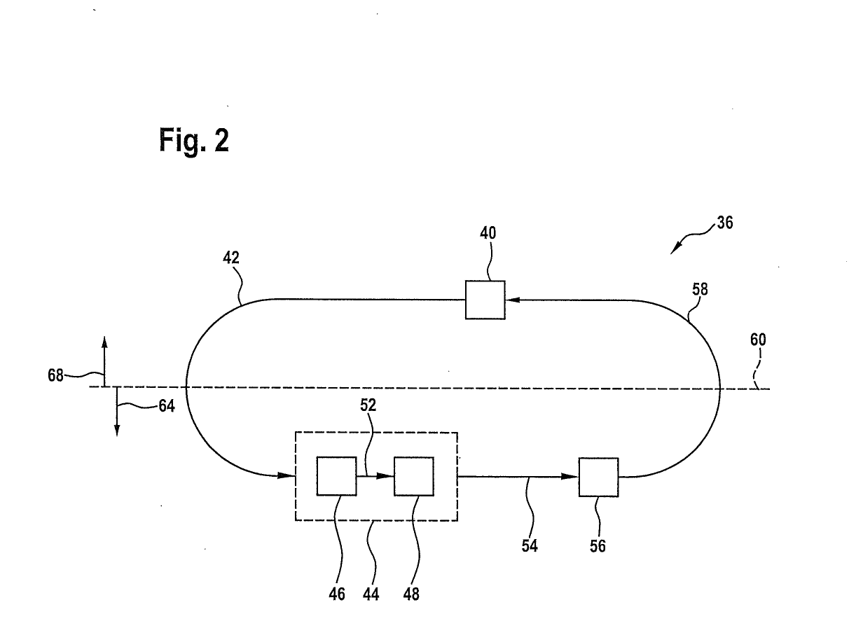

FIG. 2 shows a schematic state transition diagram 36 including the start-stop functionality of internal combustion engine 2, in which states are shown in the form of operating types of internal combustion engine 2. Accordingly, FIG. 2 shows, above a line 60 and according to an arrow 68, normal operation 40 of internal combustion engine 2, and below line 60 and according to an arrow 64, the start-stop functionality of internal combustion engine 2.

A normal operation 40 corresponds to a running internal combustion engine 2 at idling, load operation or overrun condition. If internal combustion engine 2 is to be shut down within the scope of the start-stop functionality, for instance, after a certain period of time in idle at a red traffic light, a change is made to a stop operation, according to arrow 42. Stop operation 44 includes a shut-down phase 46 in which fuel injections are withdrawn and a rest phase 48, in which crankshaft 12 of internal combustion engine 2 is essentially no longer rotating. The transition from shutting-down phase 46 to rest phase 48 is shown by arrow 52.

If internal combustion engine 2 is to be started again, based on the driver's command, for example, after the traffic light turns green, a change is made, according to arrow 54 to start operation 56. In start operation 56, starting system 14 and the systems assigned to cylinders 4, 6, 8 and 10 are actuated in such a way that, after reaching a certain condition, for instance, a certain speed of rotation, as quickly as possible a change is made to normal operation 40 according to arrow 58.

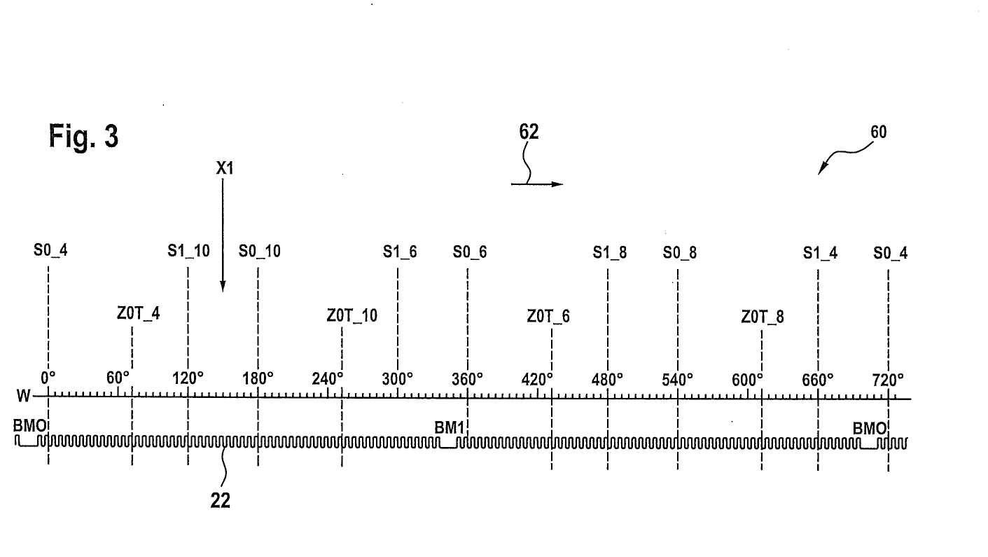

FIG. 3 shows a schematic diagram 60 of a working cycle of internal combustion engine 2 from 0° to 720° having cylinder-referenced angle of rotation S1 and S0, that are plotted horizontally on an angle axis W. Furthermore, top dead centers ZOT_4, ZOT_10, ZOT_6 and ZOT_8 are plotted according to the ignition sequence described in exemplary fashion with respect to FIG. 1. The methods described are naturally not limited to this ignition sequence and also not to the number of cylinders shown.

On angles of rotation S1 and S0, in normal operation 40, in each case functions in control unit 20 are activated and carried out in a crankshaft-synchronous manner, i.e. essentially at the time of the sweeping over of the corresponding angle of rotation S1, S0. The functions, which are activated in normal operation at angles of rotation S1 and S0, are functions which, depending on angle of rotation and form of execution of internal combustion engine 2, calculate, for example, injection timing, ignition timing and/or a charging time. Without the activation of the functions assigned to the angles of rotation, the firing of corresponding cylinders 4, 6, 8 or 10 cannot take place. Furthermore, angle of rotation signal 22 is shown in exemplary fashion, the reference location of the sensor wheel being designated by BM0 and BM1.

The functions which in normal operation 40 are activated at angles of rotation S1_10 and S0_10 are assigned to upper dead center ZOT_10, the corresponding also applying for the other angles of rotation S1 and S0 with respect to the additional cylinders 4, 6 and 8. The first possible cylinder which is able to be fired, in the present example of FIG. 1, is cylinder 10. The firing is only able to take place if the results of the functions are present, which in normal operation 40 are activated at angles of rotation S1_10 and S0_10.

In supplement, let us point out that a so-called forward displacement is also possible. Thus, at S0_10, the functionality for ZOT_8 may also be calculated.

During the coasting down of internal combustion engine 2 in shutting-down phase 46, a high synchronization stage, for instance, having a value of 30 is reduced, at entry into shutting-down phase 46, to a low synchronization stage, for instance, having a value of 0, while crankshaft 12 is at rest. In start operation 56 following stop operation 44, for angle of rotation sensor 16 used, which has continued to record the angle of rotation position during stop operation 44, a middle synchronization stage, such as 21, is selected. In start operation 56 and/or following normal operation 40, for example, after the identification of a gap within the meaning of reference points BM0 and BM1 and/or a comparison with a camshaft angle of rotation sensor, a further high synchronization stage is selected. The respectively selected synchronization stage is used in control unit 20 to value qualitatively a reliability of the recorded angle of rotation signal 22, a high synchronization stage corresponding to a high reliability and a low synchronization stage corresponding to a low one.

In shut-down phase 46, during stop operation 44, the functions of control unit 20 assigned to angles S1 and S0 are activated and carried out as long as a crankshaft position is able to be ascertained by angle of rotation sensor 16 sufficiently reliably, i.e. having a high synchronization stage. The results of the functions activated in stop operation 44 are, however, not implemented as injections, in order to bring internal combustion engine 2 temporarily to a standstill, and the results are also not taken over in start operation 56.

In stop operation 44, internal combustion engine 2 was temporarily brought to a standstill. Crankshaft sensor 16 is also active during stop operation 44 and continuously ascertains angle of rotation signal 22. According to the example of FIG. 3, control unit 20 ascertains, in or before start operation 56, whether a coasting-down angle X1 of 150°, at which internal combustion engine 2 is temporarily standing still, follows first angle of rotation S1-10 of 120°^{in rotational direction} 62. If the result of the preceding ascertainment is positive, thus if coasting-down angle X1 in rotational direction 62 follows upon first angle of rotation S1_10, the activation of the function which is assigned in normal operation 40 to first angle of rotation S1_10, is made up in start operation 56 following stop operation 44 at a second angle of rotation. Making up for the activation of the function may consist of an activation of the function at coasting-down angle X1, the second angle of rotation corresponding to coasting-down angle X1. Alternatively, the activation of the function at the second angle of rotation is also able to take place in an angular range between coasting-down angle X1 and upper dead center ZOT_10.

During shutting-down phase 46, if a start request to enter into start operation 56 comes in, a change is made directly from shutting-down phase 46 into start operation 56, and angle of rotation signal 22 may be evaluated only once upon entry into start operation 56. On the basis of this one-time evaluation, a function analogous to the making up of a function after an essentially at-rest crankshaft 12 is made up for at a second angle of rotation. Correspondingly, for all the methods described, it is not a necessary supposition that crankshaft 12 is essentially in a state at rest. Rather, all the methods described are suitable for being carried out without an at-rest phase 48 in a stop operation 44.

With regard to the additional function, whose activation in normal operation 40 is assigned to third angle of rotation S0_10, it is ascertained that third angle of rotation S0_10 follows coasting-down angle X1 in direction of rotation 62. If the result of the ascertainment is positive, that is, if third angle of rotation S0_10 follows coasting-down angle X1 in direction of rotation 62, then, in start operation 56, the additional function assigned to third angle of rotation S0_10 is activated at third angle of rotation signal S0_10.

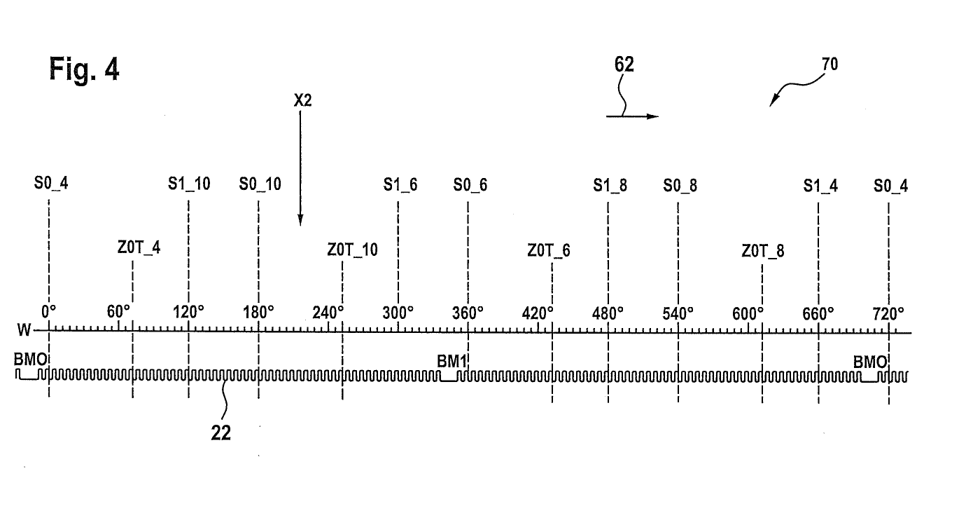

FIG. 4 shows a schematic diagram 70 of a working cycle of internal combustion engine 2 analogous to FIG. 3. By contrast to FIG. 3, internal combustion engine 2 has been brought temporarily to a standstill at a coasting-down angle X2 of 210°. It is ascertained that coasting-down angle X2 follows the two first angles of rotation S1_10 and S0_10 in direction of rotation 62. Before, or in start operation 56, the functions assigned to first angles of rotation S1_10 and S0_10 are made up for, i.e. these functions are activated, in start operation 56, at the respective second angle of rotation, that is, at coasting-down angle X2 or between coasting-down angle X2 and top dead center ZOT_10.

Furthermore, a boundary value (not shown) is provided, which is at a distance, counter to direction of rotation 62, from the respective dead center ZOT, for instance, top dead center ZOT_10, by a fixed difference value. If there is a coasting-down angle X between the boundary value and assigned dead center ZOT, the functions of the assigned cylinder, such as cylinder 10, are not made up for.

In an additional specific embodiment, an interval follows top dead center ZOT_10, in which the functions assigned to the angles of rotation are carried out in start operation 56, but the injections for cylinder 6, following top dead center ZOT_10, that is the directly following cylinder 6, are not performed. This blank-out of the injection for first cylinder 6 in start operation 56 enables reproducible starting times.

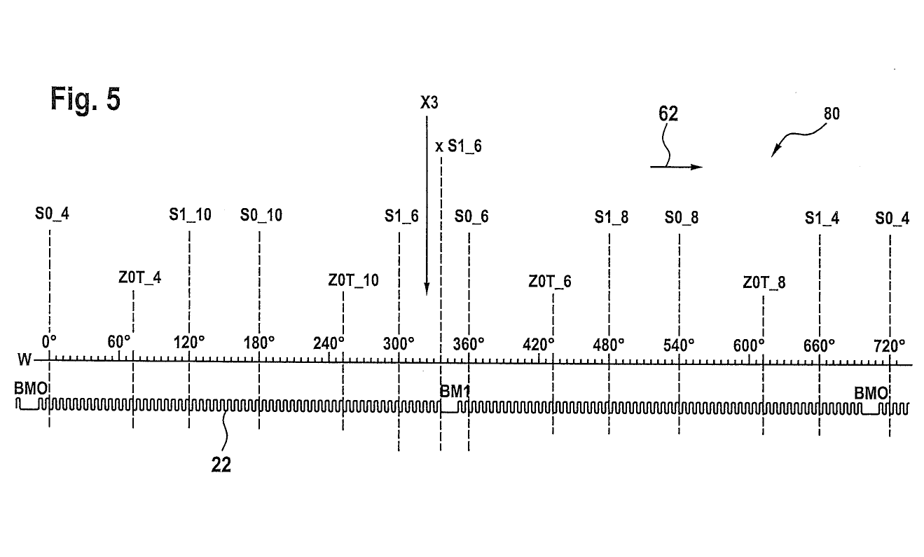

FIG. 5 shows a schematic diagram 80 of a working cycle of internal combustion engine 2 analogous to FIG. 3. By contrast to FIG. 3, internal combustion engine 2 has been brought temporarily to a standstill at a coasting-down angle X3 of 324°. The first possible cylinder that is able to be fired is cylinder 6. During start operation 56, there takes place the activation of the function assigned to angle of rotation S1_6 at second angle of rotation xS1_6 in direction of rotation 62 after coasting-down angle X3, whereby the activation of this function makes possible the firing of cylinder 6. All other functions are activated at the respectively assigned angles of rotation.

What is claimed is:

1. A method for operating an internal combustion engine, which includes an angle of rotation sensor for ascertaining angles of rotation of the internal combustion engine, the method comprising:
activating, in a normal operation, a function at a first angle of rotation;
temporarily bringing, in a stop operation, the internal combustion engine to a standstill; and
activating the function in a start operation following the stop operation at a second angle of rotation, which follows the first angle of rotation in the direction of rotation.

2. The method of claim 1, wherein it is ascertained that a coasting-down angle at which the internal combustion engine is temporarily standing still, follows the first angle of rotation in the direction of rotation, and wherein the function in the start operation following the stop operation is activated as a function of the ascertainment at the second angle of rotation.

3. The method of claim 2, wherein the second angle of rotation corresponds to the coasting-down angle.

4. The method of claim 2, wherein the second angle of rotation lies after the coasting-down angle and before an assigned top dead center.

5. The method of claim 1, wherein it is ascertained that a third angle of rotation in the direction of rotation follows the coasting-down angle, at which the internal combustion engine is temporarily standing still, and wherein an additional function, which is assigned in normal operation to the third angle of rotation, is activated in the start operation as a function of the ascertainment at the third angle of rotation.

6. A computer readable medium having a computer program, which is executable by a processor, comprising:
a program code arrangement having program code for operating an internal combustion engine, which includes an angle of rotation sensor for ascertaining angles of rotation of the internal combustion engine, by performing the following:
activating, in a normal operation, a function at a first angle of rotation;
temporarily bringing, in a stop operation, the internal combustion engine to a standstill; and
activating the function in a start operation following the stop operation at a second angle of rotation, which follows the first angle of rotation in the direction of rotation.

7. A control unit for an internal combustion engine, of a motor vehicle, comprising:
a processor configured for operating the internal combustion engine, which includes an angle of rotation sensor for ascertaining angles of rotation of the internal combustion engine, by performing the following:
activating, in a normal operation, a function at a first angle of rotation;
temporarily bringing, in a stop operation, the internal combustion engine to a standstill; and
activating the function in a start operation following the stop operation at a second angle of rotation, which follows the first angle of rotation in the direction of rotation.

8. The control unit of claim 7, wherein it is ascertained that a coasting-down angle at which the internal combustion engine is temporarily standing still, follows the first angle of rotation in the direction of rotation, and wherein the function in the start operation following the stop operation is activated as a function of the ascertainment at the second angle of rotation.
